(19) United States
(12) Patent Application Publication
(10) Pub. No.: US 2009/0019390 A1
(43) Pub. Date: Jan. 15, 2009

(54) METHOD AND DEVICE FOR EDITING MENU INTERFACE

(75) Inventor: Chien-Cheng Su, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/168,925

(22) Filed: Jul. 8, 2008

(30) Foreign Application Priority Data
Jul. 11, 2007 (TW) 96125239

(51) Int. Cl. G06F 3/048

(52) U.S. Cl. 715/810

(57) ABSTRACT

A method for editing a menu interface and a device for editing a menu interface are provided. In the invention, at least a common function option in a setting menu interface of a basic input output system (BIOS) is added to a common menu interface. In this way, a user is unnecessary to search for the function option that he wants to adjust from a plurality of function options in the setting menu interface. A setting value of the function option can be directly adjusted in the common menu interface to improve the smoothness in adjusting the setting value of the function option, which is convenient.

### CROSS-REFERENCE TO RELATED APPLICATION

This application claims the priority benefit of Taiwan application serial no. 96125239, filed on Jul. 11, 2007. The entirety of the above-mentioned patent application is hereby incorporated by reference herein and made a part of specification.

### BACKGROUND OF THE INVENTION

1. Field of the Invention

The invention relates to a mechanism for editing a menu interface and, more particularly, to a method for editing a menu interface and a device for editing a menu interface of a basic input output system (BIOS).

2. Description of the Related Art

Commonly, when a computer system is started, a basic input output system (BIOS) is started first to execute and start the power on self test (POST) to initialize peripheral hardware devices. When the BIOS executes the POST, the setting menu interface of the BIOS can be entered via defined hot keys to adjust setting values of the BIOS. The setting values of the BIOS include related parameters (such as the working voltage and the working frequency of a central processing unit) of the hardware devices such as a motherboard, an interface card, etc. The user adjusts the setting values to enable the computer system to work in the best state.

In term of the conventional method, during the POST process, the user mostly enters the setting menu interface of the BIOS by pressing the Delete key on the keyboard. After the setting menu interface is entered, the user has to search for the function option that he wants to adjust from a plurality of function options of the setting menu interface. Finally, when the user finishes adjusting, he can make the setting values stored and quit the setting menu interface. However, when the user often adjusts the setting value of the BIOS, the user has to search for the function option that he wants to adjust from a plurality of function options to set every time the user adjusts the setting value of the BIOS, which is inconvenient for the usage.

### BRIEF SUMMARY OF THE INVENTION

The invention provides a method for editing a menu interface, which adds common function options in the setting menu interface of a basic input output system (BIOS) to a common menu interface.

The invention provides a device for editing a menu interface, which provides a common menu interface and enables function options in the common menu interface to be deleted or rearranged.

The invention provides a method for editing a menu interface, which is applied to a BIOS. First, the setting menu interface of the BIOS is displayed and has a plurality of function options, wherein the function options include setting values of the BIOS. Next, a common menu interface is provided. Finally, according to the selection of the user, at least one of the function options is added to the common menu interface.

In one embodiment of the invention, the method for editing a menu interface further includes the step of displaying the common menu interface and deleting or rearranging the function options in the common menu interface according to the selection of the user.

In one embodiment of the invention, the method for editing a menu interface further includes the step of detecting whether a first hot key is enabled to determine whether to display the common menu interface. When the first hot key is enabled, the common menu interface is displayed. On the other hand, the method for editing a menu interface further includes the step of detecting whether a second hot key is enabled to determine whether to display the setting menu interface. When the second hot key is enabled, the setting menu interface is displayed.

The invention provides a device for editing a menu interface, which is applied to a BIOS and includes a control unit, a user interface, a processing unit and a storage unit. The control unit is used for displaying the setting menu interface. The user interface is used for receiving the selection of the user. The processing unit is connected to the user interface and the control unit to add the function options to the common menu interface according to the selection of the user. The storage unit is connected to the processing unit to provide or store the data of the common menu interface.

In one embodiment of the invention, the above user interface includes a first hot key and a second hot key. When the processing unit detects that the first hot key is enabled, the common menu interface is displayed via the control unit; when the processing unit detects that the second hot key is enabled, the setting menu interface is displayed via the control unit.

In the invention, common function options in the setting menu interface are added to the common menu interface. Therefore, the user is unnecessary to search for the function option that he wants to adjust in a plurality of function options, and can directly adjust the setting value of the common function options in the common menu interface, which is convenient.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing a device for editing a menu interface according to the first embodiment of the invention.

FIG. 2 is a flow chart showing a method for editing a menu interface according to the first embodiment of the invention.

FIG. 3 is a block diagram showing a device for editing a menu interface according to the second embodiment of the invention.

FIG. 4 is a flow chart showing a method for editing a menu interface according to the second embodiment of the invention.

FIG. 5 is a schematic diagram showing a setting menu interface according to the second embodiment of the invention.

FIG. 6 is a schematic diagram showing a common menu interface according to the second embodiment of the invention.

### DETAILED DESCRIPTION OF THE EMBODIMENTS

Generally speaking, when users adjust setting values of a basic input output system (BIOS), common function options are different according to different customs of the users. Therefore, the invention provides a method for editing a menu interface and a device for editing a menu interface, and then common function options are displayed according to the usage customs of the users. To make the content of the invention better understood, the preferred embodiments are taken hereinbelow to illustrate that the invention can be carried out.

### First Embodiment

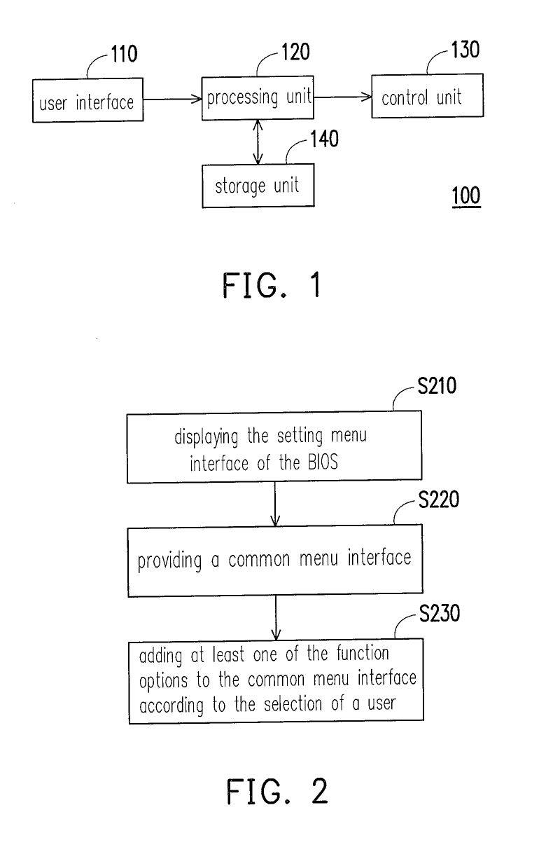

FIG. 1 is a block diagram showing a device for editing a menu interface according to the first embodiment of the invention. As shown in FIG. 1, a device for editing a menu interface 100 includes a user interface 110, a processing unit 120, a control unit 130 and a storage unit 140. The processing unit 120 is connected to the user interface 110 and the control unit 130. The storage unit 140 is connected to the processing unit 120 to provide a common menu interface. The storage unit is, for example, a nonvolatile random access memory (NVRAM) or a complementary metal oxide semiconductor (CMOS).

The user interface 110 is used for receiving actions (such as receiving the action of the user by a keyboard) such as the selection of the user, the input of the user, the operation of the user, etc. to enable the processing unit 120 to detect the information received by the user interface 110 to work. According to the information received by the user interface 110, the processing unit 120 notifies the control unit 130 to execute a corresponding action.

In detail, the processing unit 120 enables a function option in the setting menu interface of the BIOS to be added to the common menu interface according to the selection of the user. The setting menu interface has all preset function options of the BIOS, and the function options includes setting values of the BIOS, such as related parameters of peripheral hardware devices. Like the “My Favorites” option, the common menu interface makes common function options disposed in the same page to facilitate the users to adjust the setting values of the BIOS.

The control unit 130 displays the setting menu interface or the common menu interface according to the selection of the user received by the user interface 110 detected by the processing unit 120. The control unit 130 closes the setting menu interface or the common menu interface according to the operation of the user received by the user interface 110.

The steps of the method for editing a menu interface are illustrated hereinbelow with the device for editing a menu interface 100. FIG. 2 is a flow chart showing a method for editing a menu interface according to the first embodiment of the invention. As shown in FIG. 1 and FIG. 2, first, in the step S210, the setting menu interface of the BIOS is displayed via the control unit 130. In detail, when the user interface 110 receives the selection of the user, the processing unit 120 notifies the control unit 130 to display the setting menu interface. After the setting menu interface is displayed, the preset setting value of each function option of the BIOS can be loaded via the processing unit 120. The input of the user is received via the user interface 110, and the processing unit 120 is used to adjust the setting values of the function options.

Next, in the step S220, a common menu interface is provided via the storage unit 140. In the common menu interface, a plurality of common function options can be preset in the common menu interface, or the common menu interface can be blank without any function option. Herein, the actual condition of the common menu interface can be determined according to actual application conditions and is not limited.

Finally, in the step S230, the processing unit 120 detects the selection of the user, and at least one of function options preset in the setting menu interface is added to the common menu interface according to the selection of the user. For example, after the user selects one function option in the setting menu interface of the BIOS, he presses the key which is defined as “add” (such as the Insert key on the keyboard) to make the function option added to the common menu interface.

In addition, in the step S230, the “Save & Exit Setup” selection can be received via the user interface 110. At this time, according to the selection of the user, the processing unit 120 enables the added function option or the original content of the common menu interface to be stored in the storage unit 140, and notifies the control unit 130 to close the setting menu interface. On the other hand, when the user interface 110 receives the “Quit” selection, the processing unit 120 does not execute the action of storing and directly notifies the control unit 130 to close the setting menu interface.

An embodiment is taken hereinbelow to illustrate from the operation aspect of the user. First, the user selects to enter the setting menu interface of the conventional BIOS to add a function option which is often adjusted to the common menu interface. After the function option is added, the user selects “Save & Exit Setup” option to make the added function option stored and quit the setting menu interface of the convention BIOS. That is, the function option which is added to the common menu interface is stored.

In the above embodiment, the user can add common function options from the setting menu interface to the common menu interface. Certainly, in the user-defined common menu interface, the user can also delete or rearrange the function options in the common menu interface. Another embodiment is taken hereinbelow to further illustrate steps of the method for editing a menu interface in detail.

### Second Embodiment

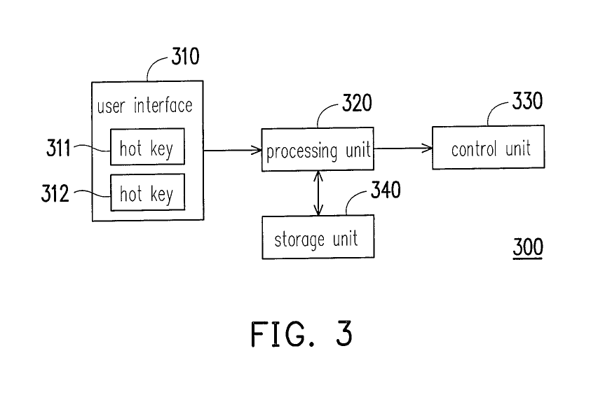

FIG. 3 is a block diagram showing a device for editing a menu interface according to the second embodiment of the invention. As shown in FIG. 3, a device for editing a menu interface 300 includes a user interface 310, a processing unit 320, a control unit 330 and a storage unit 340. The user interface 310 includes two groups of hot keys 311 and 312. In the device for editing a menu interface 300 of the embodiment, function and connection relationship of each component are the same with or similar to function and connection relationship of each component of the device for editing a menu interface 100 of the above embodiment, and they are not described for concise purpose.

The difference between the embodiment and the above embodiment is that, in the embodiment, the hot keys 311 and 312 are utilized to display the setting menu interface and the common menu interface. To conveniently illustrate, in the following embodiment, the hot key 311 is supposed to be used for displaying the setting menu interface, and hot key 312 is supposed to be used for displaying the common menu interface. When the processing unit 320 detects that the hot key 311 is enabled, the setting menu interface is displayed via the control unit 330. When the processing unit 320 detects that the hot key 312 is enabled, the common menu interface is displayed via the control unit 330, and added function options are loaded from the storage unit 340 and are displayed on the common menu interface via the control unit 330.

In addition, in the embodiment, the processing unit 320 can further execute the editing action on the function options in the common menu interface. In detail, the processing unit 320 can delete or rearrange the function options in the common menu interface according to the selection of the user received by the user interface.

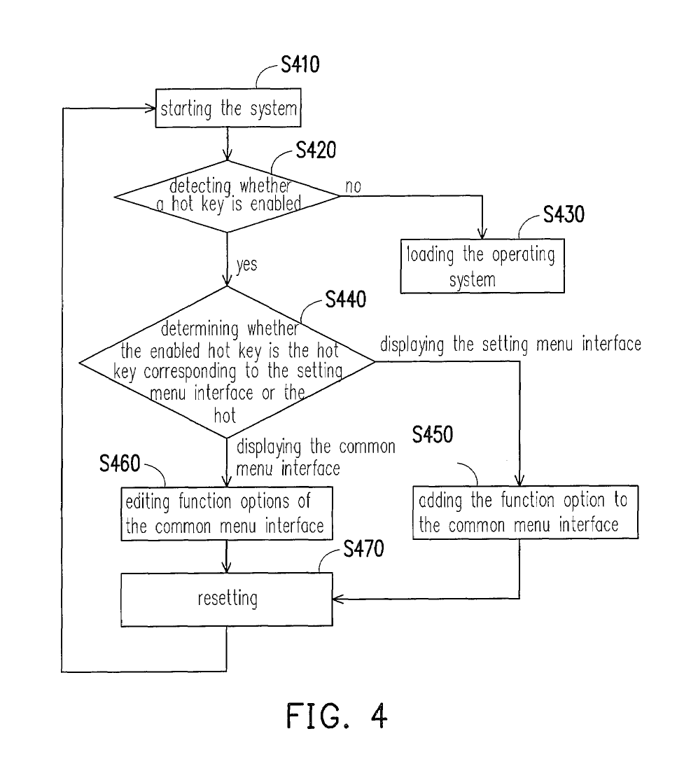

Each step of the method for editing a menu interface is illustrated hereinbelow in further detail with the device for editing a menu interface 300. FIG. 4 is a flow chart showing a method for editing a menu interface according to the second embodiment of the invention. As shown in FIG. 3 and FIG. 4, in the step S410, first, the system is started and the power on self test (POST) is executed via the BIOS to initialize peripheral hardware devices. Next, when the POST is executed via the BIOS, as shown in the step S420, the processing unit 120 detects whether a hot key (the hot keys 311 and 312) is enabled, that is, the processing unit 120 detects whether the user presses a defined hot key.

If the processing unit 320 does not detect any enabled hot key, the BIOS executes the step S430, that is, after the POST is finished, the operating system is loaded. If the processing unit 320 detects that one of the hot keys is enabled, as shown in the step S440, the processing unit 320 determines whether the enabled hot key is the hot key 311 corresponding to the setting menu interface or the hot key 312 corresponding to the common menu interface.

Generally speaking, during the POST process, since the user can make different frames displayed via different hot keys. For example, the user can make the system enter a safe mode via the “F8” key or enter the setting menu interface of the BIOS via the “Delete” key. Therefore, the system should determine what the enabled hot key is to display the corresponding frame. If the user wants to make the setting menu interface of the BIOS displayed, he should press the hot key 311 when the BIOS executes the POST; if the user wants to make the common menu interface displayed, he needs to press the hot key 312.

In the step S440, when the processing unit 320 detects that the hot key 311 corresponding to the setting menu interface is enabled, it notifies the control unit 330 to display the setting menu interface. For example, when the processing unit 320 detects that the “Delete” key on the keyboard is enabled, the setting menu interface is displayed. At this time, in the step S450, the user can make common function options added to the common menu interface from the setting menu interface. For example, as shown in the step S320 in the above embodiment, the function options are added to the common menu interface via the defined key.

Next, during the process of displaying the setting menu interface, when the user interface 310 receives the “Save & Exit Setup” selection, the processing unit 320 enables the function options added by the user or the original content of the common menu interface to be stored to the storage unit 340 and enables the setting menu interface to be closed via the control unit 330. Or, when the user interface 310 receives the “Quit” selection, the setting menu interface is directly closed. Next, as shown in the step S470, the system resets the above adjusted content to restart.

In the step S440, if the processing unit 320 detects that the user presses the hot key 312 for displaying the common menu interface of the BIOS, the common menu interface is displayed via the control unit 330. At this time, as shown in the step S460, the user can edit function options in the common menu interface. In detail, when the user presses the hot key 312 to make the common menu interface displayed during the POST process, the processing unit 320 enables the function options which are previously added by the user to be loaded from the storage unit 340 and displayed, and then the user can adjust the setting values of the function options of the BIOS. The function options can be deleted or rearranged via the processing unit 320.

For example, during the process of displaying the common menu interface, when the processing unit 320 detects that the “Delete” key is enabled, the function option is deleted from the common menu interface. When the processing unit 320 detects that the “+” key or the “−” key is enabled, the function option is moved upward or downward to rearrange the sequence of the function options. However, the above is only an example and does not limit the scope of the invention.

The common menu interface can be operated in the same way as the setting menu interface, and when the user interface 310 receives the “Save & Exit Setup” selection, after the edited common menu interface is stored, the common menu interface is closed; when the user interface 310 receives the “Quit” selection, the common menu interface is directly closed. Next, as shown in the step S470, the system resets the above adjusted content to restart.

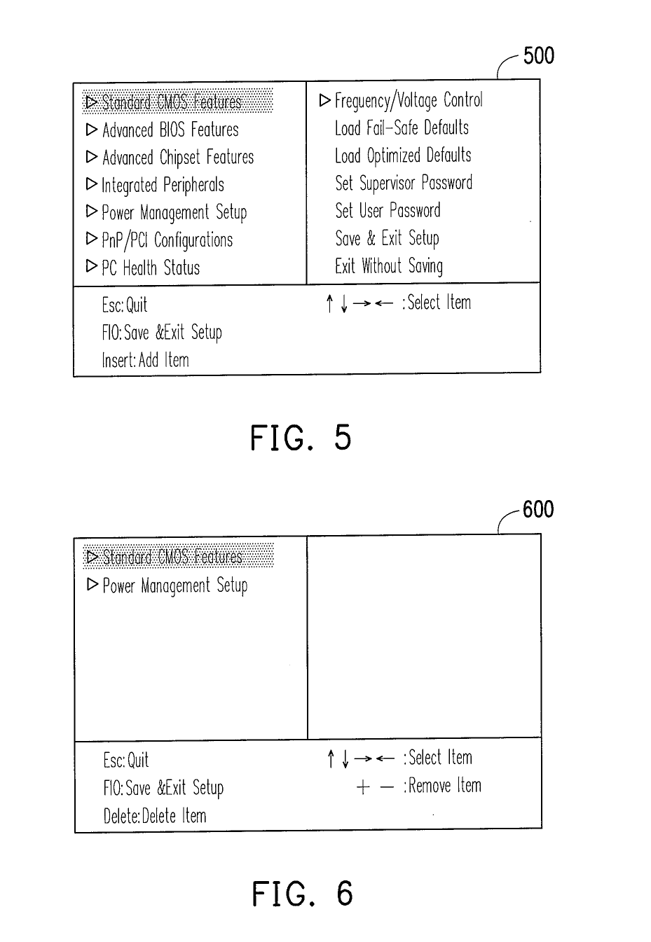

The setting menu interface and the common menu interface in the second embodiment are illustrated in detail according to the actual application. FIG. 5 is a schematic diagram showing a setting menu interface according to the second embodiment of the invention. As shown in FIG. 5, a setting menu interface 500 includes all preset function options and key reminders such as “Esc”, “F1038 , “Insert”, “↑”“↓”, “→”, “←”, etc. In the embodiment, the user can select the function option that he wants to add to the common menu interface via the directional keys “↑”, “↓”, “→38 , “←” in the keyboard.

As shown in FIG. 5, after the user selects “Standard COMS Features” option, he can press the “Insert” key to make the selected function option added to the common menu interface. When the user wants to add another function option to the common menu interface, the above operation steps are followed, that is, after the function option is selected via the direction keys, the “Insert” key is pressed. After the user adds all common function options to the common menu interface, he can make the added function options stored via pressing the F10 key, and then quit the setting menu interface 500 to restart.

If the F12 key is defined to be used for displaying the common menu interface, when the system is started, the user can make the common menu interface display via the F12 key. FIG. 6 is a schematic diagram showing a common menu interface according to the second embodiment of the invention. In FIG. 6, a common menu interface 600 includes user-defined common function options and key reminders such as “Esc”, “F10”, “Delete”, “+”, “−”, and four directional keys, etc. The common function options which are previously added are displayed in the common menu interface 600, and therefore, a plurality of steps of operating the direction keys are omitted when the user selects the function options. In addition, the user can delete the function options on the common menu interface 600 via the “Delete” key or rearrange the sequence of the function options via the “+” key and the “−” key to make the common menu interface 600 further satisfy with the usage custom of the user.

To sum up, the method for editing a menu interface and the device for editing a menu interface of the invention at least have the following advantages.

First, common function options are added to a common menu interface according to the usage custom of a user to improve the smoothness in adjusting setting values of the BIOS, which is convenient.

Second, the user can arrange the function options according to his hobbies by himself, and the usage is more flexible.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for editing a menu interface, which is applied to a basic input output system (BIOS), the method for editing a menu interface comprising the steps of:
displaying a setting menu interface of the BIOS, wherein the setting menu interface has a plurality of function options comprising setting values of the BIOS;
providing a common menu interface; and
adding at least one of the function options to the common menu interface according to the selection of a user.

2. The method for editing a menu interface according to claim 1, further comprising the steps of:
displaying the common menu interface; and
deleting or rearranging the function options in the common menu interface according to the selection of the user.

3. The method for editing a menu interface according to claim 2, wherein after the step of displaying the common menu interface, the method further comprises the step of:
receiving the input of the user to adjust the setting value of the function option.

4. The method for editing a menu interface according to claim 2, further comprising the steps of:
detecting whether a first hot key is enabled to determine whether to display the common menu interface; and
displaying the common menu interface when the first hot key is enabled.

5. The method for editing a menu interface according to claim 4, wherein when the first hot key is enabled, the step of displaying the common menu interface comprises the step of:
loading and displaying the function option which is added from the setting menu interface.

6. The method for editing a menu interface according to claim 2, wherein after the step of displaying the common menu interface, the method further comprises the step of:
detecting the selection of the user to quit the common menu interface directly or after storing.

7. The method for editing a menu interface according to claim 1, wherein after the step of displaying the setting menu interface, the method further comprises the step of:
detecting the selection of the user to quit the setting menu interface directly or after storing.

8. The method for editing a menu interface according to claim 1, further comprising the steps of:
detecting whether a second hot key is enabled to determine whether to display the setting menu interface; and
displaying the setting menu interface when the second hot key is enabled.

9. The method for editing a menu interface according to claim 1, wherein the common menu interface is stored at one of a nonvolatile random access memory (NVRAM) and a complementary metal oxide semiconductor (COMS).

10. A device for editing a menu interface, which is applied to a basic input output system (BIOS), the device for editing a menu interface comprising:
a control unit for displaying a setting menu interface which has a plurality of function options, wherein the function options comprise setting values of the BIOS;
a user interface for receiving the selection of a user;
a processing unit which is connected to the user interface and the control unit and is used for adding at least one of the function options to the common menu interface according to the selection of the user; and
a storage unit which is connected to the processing unit and is used for providing the common menu interface.

11. The device for editing a menu interface according to the claim 10, wherein the user interface comprises:
a first hot key; and
a second hot key,
wherein when the processing unit detects that the first hot key is enabled, the common menu interface is displayed via the control unit, and when the processing unit detects that the second hot key is enabled, the setting menu interface is displayed via the control unit.

12. The device for editing a menu interface according to the claim 10, wherein the processing unit further enables the function option added to the common menu interface to be stored to the storage unit.

13. The device for editing a menu interface according to the claim 12, wherein the processing unit further enables the added function option to be loaded from the storage unit and displayed via the control unit when the enabled first hot key is detected.

14. The device for editing a menu interface according to the claim 10, wherein the processing unit further enables the function options in the common menu interface to be deleted or rearranged according to the selection of the user received by the user interface.

15. The device for editing a menu interface according to the claim 10, wherein the user interface can further receive the input of the user to adjust the setting value of the function option via the processing unit.

16. The device for editing a menu interface according to the claim 10, wherein the user interface can further receive the operation of the user to close the common menu interface via the control unit and to store the common menu interface via the processing unit.

17. The device for editing a menu interface according to the claim 10, wherein the storage unit comprises one of a nonvolatile random access memory (NVRAM) and a complementary metal oxide semiconductor (COMS).
